(19) United States
(12) Patent Application Publication
(10) Pub. No.: US 2009/0159661 A1
(43) Pub. Date: Jun. 25, 2009

(54) Self-service terminal

(76) Inventor: Ricardo F. Sanches, Dundee (GB)

Correspondence Address: MICHAEL CHAN;NCR CORPORATION, 1700 SOUTH PATTERSON BLVD, DAYTON, OH, 45479-0001, US

(21) Appl. No.: 12/004,359

(22) Filed: Dec. 20, 2007

(51) Int. Cl. G06Q 40/00

(52) U.S. Cl. 235/379

(57) ABSTRACT

A self-service terminal comprises a Web client for connecting to a Web server remote from the terminal, and an error recovery agent. The terminal also includes a display for presenting the rendered information to the customer, and at least one customer interface device for receiving media from the customer under control of the Web client. The error recovery agent executes on the terminal and is operable to monitor the Web client to detect any failure. In the event of a failure, the error recovery agent (i) takes control of the display and the at least one customer interface device from the Web client, (ii) returns inserted media to the customer (iii) informs the customer about a resolution of any pending transaction when the failure occurred, and (iv) informs the Web server of actions taken regarding the pending transaction.

### BACKGROUND

The present invention relates to improvements in or relating to self-service terminals (SSTs).

SSTs are public access devices that are suitable for allowing a customer to conduct a transaction or to access information in an unassisted manner and/or in an unattended environment.

Common examples of SSTs include automated teller machines (ATMs), information kiosks, financial services centers, bill payment kiosks, lottery kiosks, postal services machines, check-in and check-out terminals such as those used in the hotel, car rental, and airline industries, retail self-checkout terminals, vending machines, and the like.

Some types of SSTs, such as ATMs, are owned, deployed, and operated by organizations having multiple different channels through which their customers conduct transactions and access information. These channels may include the World Wide Web (hereafter the Web), a call center, SSTs, and the like.

To provide a uniform and consistent customer interface, organizations would like to have common server software serving the different channels. This would have the additional advantage of facilitating software updates and deployment of new functionality by centrally updating the server software. This would ensure that every channel having a graphical user interface would immediately access the new branding, functionality, and the like provided by the updated server software.

Many organizations would like to use Web technologies to implement this server software because Web technologies are ubiquitous and independent of the hardware associated with the channel.

One problem with implementing Web technologies on a SST is that if the SST loses communication with a Web server, then the SST will not be able to continue with a transaction, and a customer will not know the status of a transaction request, and will not be able to retrieve any deposited media (such as banknotes, ATM cards), and the like. This is unacceptable for many types of SST, such as ATMs. The SST would also have to ensure that it did not continue with any transaction that was part-way through execution when the communication is lost.

### SUMMARY

According to a first aspect of the present invention there is provided a self-service terminal comprising: a Web client for connecting to a Web server remote from the terminal, the Web client being operable to render information to a customer of the terminal and to parse commands received from the Web server; a display for presenting the rendered information to the customer; at least one customer interface device for interfacing with the customer under control of the Web client; and an error recovery agent executing on the terminal and operable to monitor the Web client to detect any failure, and in the event of a failure, (i) to take control of the display and the at least one customer interface device from the Web client, (ii) to return inserted media to the customer (iii) to inform the customer about a resolution of any pending transaction when the failure occurred, and (iv) to inform the Web server of actions taken regarding the pending transaction.

The Web client may be a Web browser, a Web browser component (that is, without any toolbars or other buttons), or the like.

The customer interface device may be a media receiving device selected from: a card reader, a cash dispenser, a check depository, a note acceptance device, a currency recycling device, or the like.

A plurality of customer interface devices may be provided, including media receiving devices listed in the preceding sentence. The customer interface devices may also include a receipt printer, a statement printer, an encrypting keypad, a barcode scanner, and the like.

The error recovery agent may also be operable to control internal devices, such as a journal printer, a PC core, a network communication device, and the like.

The failure may be due to a communications problem, information that cannot be rendered by the Web client, commands that cannot be parsed by the Web client, and the like.

The error recovery agent may be operable to capture any deposited media that cannot be returned to the customer, or that is returned to the customer but not removed by the customer.

The error recovery agent may be programmable, so that the error recovery agent can be configured to take actions as desired by the owner or operator of the self-service terminal. For example, one ATM owner may desire to capture any valuable media (such as banknotes) deposited by a customer and credit the customer's account; whereas, another ATM owner may prefer to return any valuable media (such as banknotes) deposited by a customer to that customer. This can be achieved by programming the error recovery agent accordingly. The error recovery agent may be provided with a graphical user interface to allow an ATM owner to configure its operation.

The error recovery agent may have a dedicated communications link with the Web server, such as a dial-up cellular radiofrequency connection, so that the error recovery agent can communicate directly with the Web server. Alternatively, the error recovery agent may communicate with the Web server via the same communications channel as the Web client, or via the Web client. The error recovery agent may be implemented as a Web-based client, in addition to the Web client that is operable to render information to a customer of the terminal and to parse commands received from the Web server.

According to a second aspect of the present invention there is provided a method of operating a self-service terminal comprising: connecting to a Web server remote from the terminal to receive information and commands therefrom; rendering the received information to a customer of the terminal; parsing the received commands to control one or more customer interface devices; detecting any communication failure with the remote Web server, and in the event of a communication failure; passing control of the one or more customer interface devices to a recovery agent; informing the customer about a resolution of any pending transaction using the recovery agent; and informing the Web server, on restoration of communications, of actions taken regarding the pending transaction.

The method may comprise the further step of returning inserted media to the customer using the recovery agent.

The step of informing the Web server, on restoration of communications, of actions regarding the pending transaction may include informing the Web server of actions taken by the recovery agent.

According to a third aspect of the present invention there is provided a method of recovering a self-service terminal having a transaction flow controlled by a remote Web server, the method comprising: detecting a failure with the remote Web server; accessing a local transaction flow, in response to the detected failure; informing the customer about a resolution of any pending transaction using the local transaction flow; and informing the Web server of actions taken regarding the pending transaction using the local transaction flow.

The method may comprise the further step of returning inserted media to the customer using the local transaction flow.

This aspect of the invention allows control of customer interface devices to be passed to a recovery agent implementing a local transaction flow.

The step of informing the-Web server of actions taken regarding the pending transaction may be performed subsequent to resolution of the failure with the remote Web server. In other embodiments, the step of informing the Web server of actions taken regarding the pending transaction may be performed independently of any resolution of the failure with the remote Web server; for example, where the recovery agent has independent communication with the Web server.

As used herein a transaction flow refers to the sequence of screens and the logic that controls the next screen to be presented based on an event or a selection made by a customer at the current screen. The term “screen” is used herein to denote the graphics, text, controls (such as menu options), and such like, that are presented on an SST display; the term “screen” as used herein does not refer to the hardware (that is, the display) that presents the graphics, text, controls, and such like.

By virtue of this aspect of the invention, a self-service terminal can be controlled remotely by a Web server for as long as the Web server is operating correctly, but if an error occurs (such as a communication error, a failure of the Web server to respond to a request, a message that is unparseable, or the like), then a local error recovery agent (implemented in software) can be used to terminate the transaction in a controlled manner. This may involve returning media to the customer. This reduces customer inconvenience and increases customer confidence that the transaction will not be inappropriately applied to the customer's account. Once the Web server is back in operation, the error recovery agent can inform the Web server of actions it has taken so that the Web server can update its records, for example, to reverse a transaction, to complete a transaction, or the like. Since the error recovery agent has a local transaction flow (that is, the necessary logic and screens are stored locally), there is no requirement for communication with the Web server for the error recovery agent to control the customer interface devices.

The error recovery agent may register with each of the media receiving devices so that it is notified whenever a customer inserts media, such as a card, cash, or the like.

Until the failure is resolved, the error recovery agent may present a screen informing customers that the SST is out of service.

Although the error recovery agent may not be able to execute any transactions for customers, it is able to complete a transaction and inform the Web server of what actions were taken, thereby ensuring that the customer and the Web server are aware of what has happened. If a failure occurs at the end of a transaction, or as part of a transaction that the SST owner is willing to credit to the customer's account even when a failure occurs (such as a cash deposit transaction), then the error recovery agent may be able to complete the transaction, so that it may appear to the customer that the transaction was completed as normal.

According to a fourth aspect of the invention there is provided a computer program comprising program instructions for implementing all of the steps of the second aspect of the invention.

According to a fifth aspect of the invention there is provided a computer is program comprising program instructions for implementing all of the steps of the third aspect of the invention.

The computer program may be embodied on a record medium, conveyed on an electrical carrier signal, stored in a computer memory, or the like.

According to a sixth aspect of the invention there is provided a system comprising a Web server in communication with the self-service terminal of the first aspect of the invention.

According to a seventh aspect of the invention there is provided an error recovery agent for use with a Web client, the error recovery agent being operable to monitor the Web client-and devices controlled by the Web client and to take control from the Web client in the event of a trigger condition.

The trigger condition may be an error code, a timeout, an unparseable command, a predefined event or sequence of events, or the like.

According to an eighth aspect of the invention there is provided a self-service terminal operable in a first mode of operation in which a remote server controls the terminal, and operable in a second mode of operation in which a local program controls the terminal instead of the remote server in the event of an error condition arising.

By virtue of this aspect of the invention remote transaction flow logic is used during the first mode of operation and local transaction flow logic is used during the second mode of operation.

The error condition may relate to communications with the remote server, failure of a device within the self-service terminal, or the like.

The second mode of operation may involve the local program providing information to the remote server about actions taken while the self-service terminal was operated under local control.

### BRIEF DESCRIPTION OF THE DRAWINGS

These and other aspects of the present invention will be apparent from the following specific description, given by way of example, with reference to the accompanying drawings, in which:

FIG. 1 is a pictorial front view of a self-service terminal according to one embodiment of the present invention;

FIG. 2 is a simplified schematic diagram showing the internal components of the terminal of FIG. 1, including an error recovery agent;

FIG. 3 is a block diagram of a network including the terminal of FIG. 1;

FIGS. 4A and 4B together from a flowchart illustrating normal operation of the terminal of FIG. 1 for a deposit transaction;

FIG. 5 is a schematic diagram illustrating a part (the status table) of the error recovery agent of FIG. 2; and

FIGS. 6A and 6B are flowcharts illustrating operation of the error recovery agent of FIG. 2 when a fault occurs during the deposit transaction of FIGS. 4A and 4B.

### DETAILED DESCRIPTION

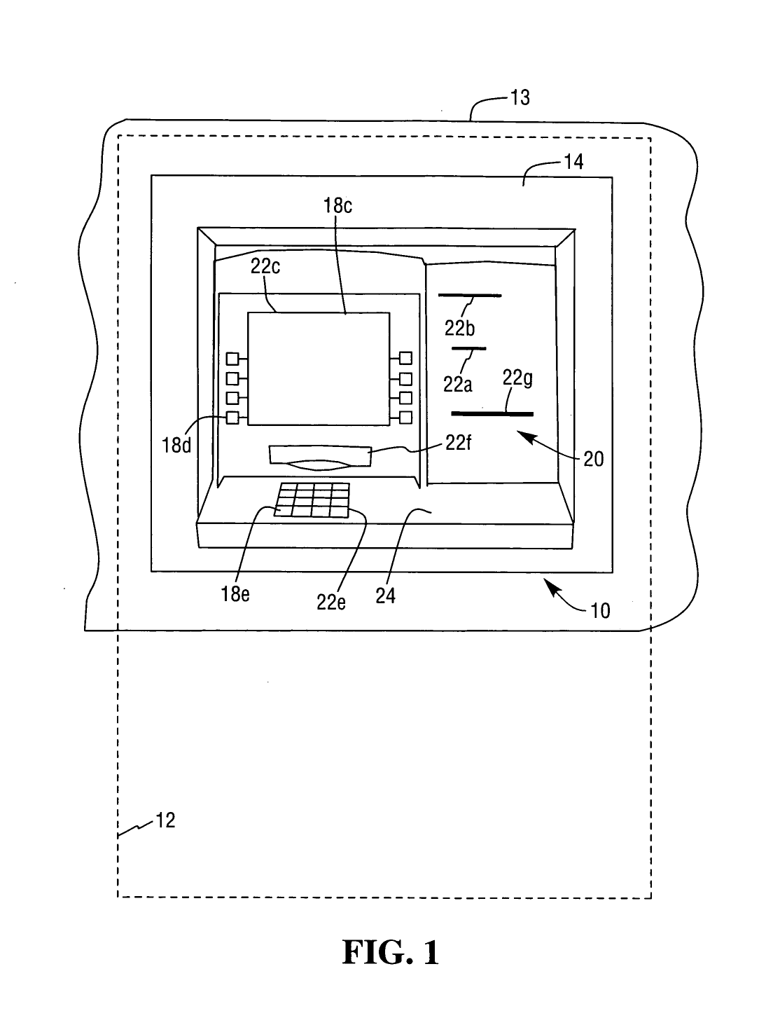

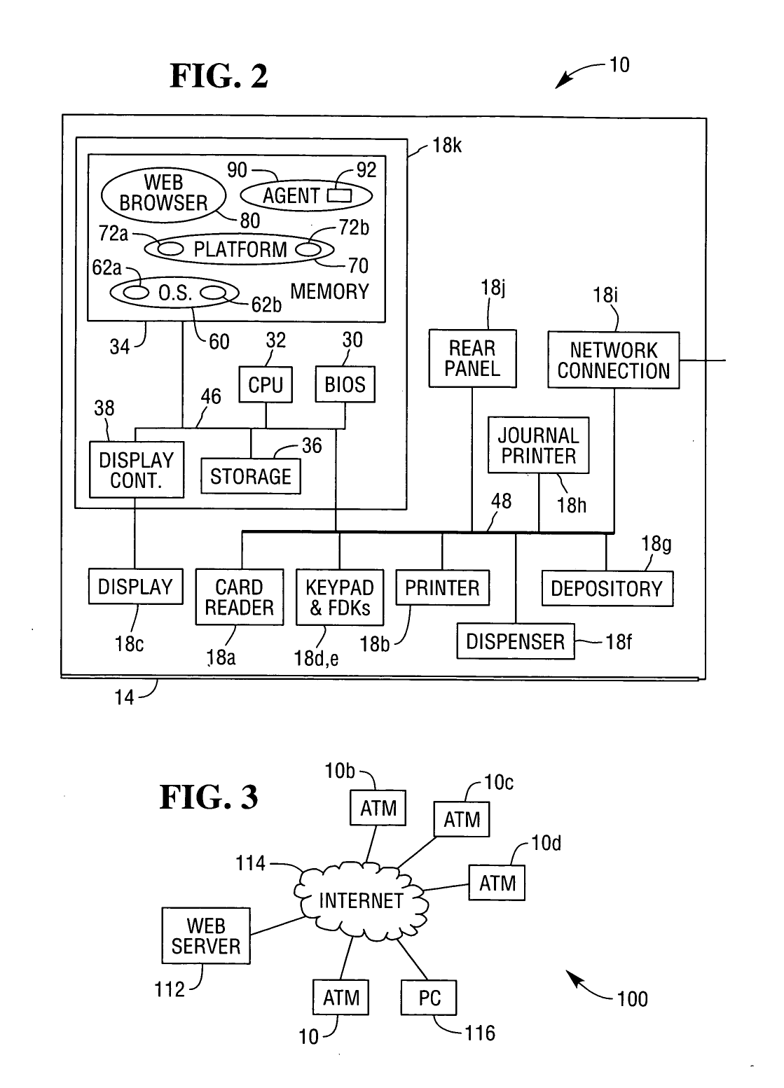

Reference is first made to FIG. 1, which is a pictorial front view of a self-service terminal 10, in the form of a through-the-wall (TTW) ATM, according to one embodiment of the invention. Reference is also made to FIG. 2, which is a schematic diagram illustrating internal devices mounted within the ATM 10 of FIG. 1.

The ATM 10 is owned and operated by a financial institution.

The ATM 10 has a chassis 12 (shown in dotted line) protruding in part through an aperture in a wall 13, and on which is mounted a plastic fascia 14. The fascia 14 provides part of a user interface 20 to allow a customer to interact with the ATM 10. In particular, the fascia 14 has apertures 22 aligning with devices 18 when the fascia 14 is moved to the closed position.

The fascia 14 defines: a card reader slot 22a aligning with a card reader device 18a; a receipt printer slot 22b aligning with a receipt printer device 18b; a display aperture 22c aligning with a display 18c and associated function display keys (FDKS) 18d disposed as two columns, each on opposing sides of the display 18c; a keypad aperture 22e through which an encrypting keypad device 18e protrudes; a dispenser slot 22f aligning with a dispenser device 18f; and a cash depository slot 22g aligning with a cash depository 18g.

Referring now to FIG. 2, the ATM 10 also includes the following internal devices 18 that are not directly viewed or accessed by a customer during the course of a transaction. These devices 18 include: a journal printer device 18h for creating a record of every transaction executed by the ATM 10, a network connection device 18i for accessing a remote authorization system (not shown), a rear operator panel 18j, and a controller device 18k (in the form of a PC core) for controlling the operation of the ATM 10, including the operation of the other devices 18. These devices 18h,i,j,k are all mounted within the chassis 12 of the ATM 10.

The controller 18k comprises a BIOS 30 stored in non-volatile memory, a microprocessor 32, associated main memory 34, storage space 36 in the form of a magnetic disk drive, and a display controller 38 in the form of a graphics card.

The display 18c is connected to the microprocessor 32 via the graphics card 38 and one or more internal controller buses 46. The other ATM devices (18a, b, and 18d to 18j) are connected to the ATM controller 18k via a device bus 48 and the one or more internal controller buses 46.

Initialization of the ATM

When the ATM 10 is booted up, the microprocessor 32 accesses the magnetic disk drive 36 and loads the main memory 34 with software components, as will now be described.

Operating System

The microprocessor 32 loads an operating system kernel 60 into the main memory 34. In this embodiment, the operating system is a Windows XP (trade mark) operating system, available from Microsoft Corporation (trade mark). The operating system includes a plurality of device drivers 62a,b, . . . for interfacing with standard computing devices such as the magnetic disk drive 36, the display 18c, USB ports, and such like.

Run-Time Platform

The microprocessor 32 also loads a run-time platform 70 into the main memory 34. In this embodiment, the runtime platform 70 is a set of APTRA (trade mark) XFS components, available from NCR Corporation, 1700 S. Patterson Blvd., Dayton, Ohio 45479, U.S.A. The run-time platform 70 provides a range of programming facilities specific to self-service terminal devices and services, and also provides a CEN XFS-compliant interface to the standard computing devices. This CEN XFS interface is used to instruct the devices 18 to perform operations, and is also used to obtain device status and fault management information. The platform comprises a plurality of self-service device drivers 72a,b, . . . that interface with self-service specific devices.

Control Application—Web browser

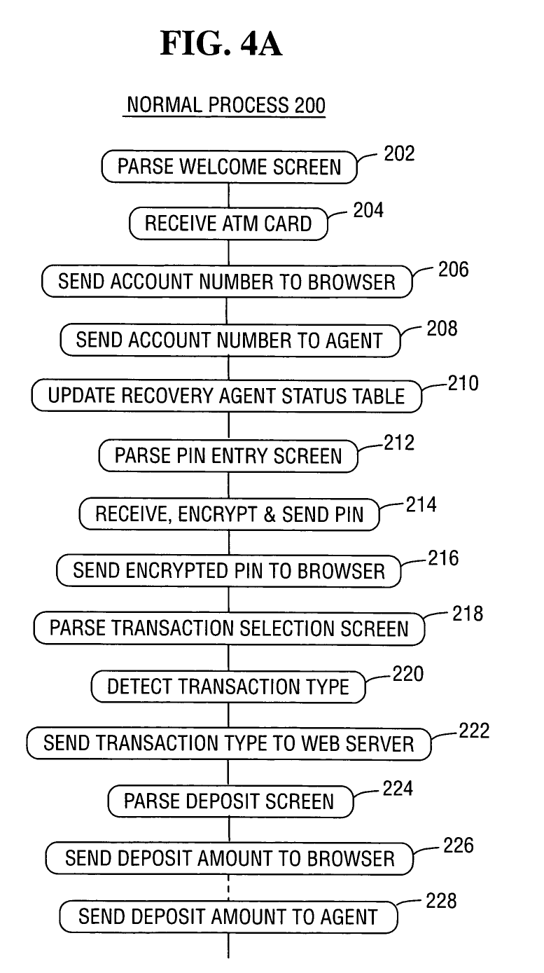

The microprocessor 32 also loads a Web client 80 (which acts as a control application) into the main memory 34. In this embodiment, the Web client 80 is a Web browser component, such as an Internet Explorer (trade mark) browser pane (referred to herein as a Web browser for simplicity). The Web browser 80 includes, or accesses, code for parsing instructions received from a remote Web server (FIG. 3), and also renders information on the ATM display 18c.

By parsing code received from the Web server (FIG. 3), the Web browser 80 is able to provide transaction processing functions (for customers and for maintenance personnel) and ATM device management functions.

Error Recovery Agent

The microprocessor 32 also loads an error recovery agent 90 into the main memory 34. The error recovery agent 90 monitors the devices 18 within the ATM 10, and records the status of at least some of the devices 18 and events taking place by registering with those devices to receive event notifications via a CEN XFS interface. For example, the error recovery agent 90 registers with the card reader device 18a so that the agent 90 is notified when the card reader device 18a receives a card from a customer; similarly, the agent 90 registers with the cash dispenser device 18f so that the agent is notified when the cash dispenser device 18f is counting cash for dispensing to a customer; the agent 90 also registers with the cash depository 18g so that the agent 90 is notified by the cash depository 18g when cash has been received, and the like.

The error recovery agent 90 communicates with the runtime platform 70 using XFS commands. This enables the error recovery agent 90 to control the devices 18 within the ATM 10.

The error recovery agent 90 also communicates with the Web browser 80 using a predefined protocol. The predefined protocol enables the error recovery agent 90 to receive information about whether the remote Web server is communicating with the Web browser 80. In this embodiment, the Web browser sends a heartbeat to the agent 90 at predetermined time intervals (every two seconds in this embodiment) to indicate that the Web browser 80 is still functioning correctly.

Financial Institution Network

Reference is now made to FIG. 3, which is a block diagram of a financial institution network 100 including the ATM 10. The financial institution owning the ATM 10 also provides a Web server 112, which is coupled to ATM 10 and other ATMs 10b,c,d that are similar to ATM 10 by the Internet 114.

Home banking customers of the financial institution can also connect to the Web server 112 via the Internet 114 using standard personal computers 116, only one of which is illustrated in FIG. 3 for clarity.

Normal Operation of the ATM

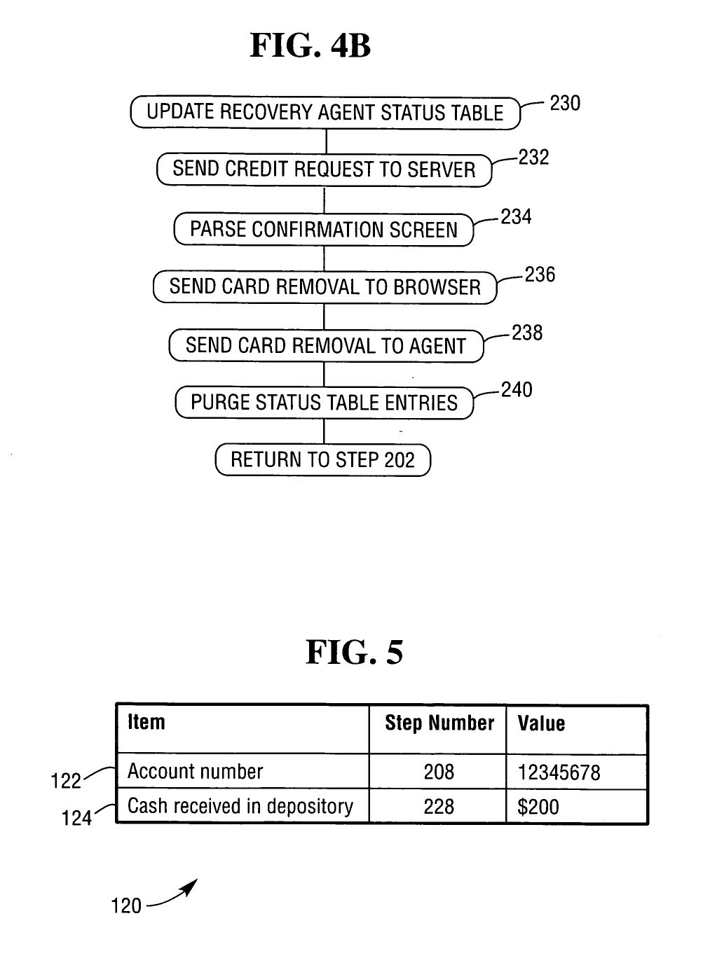

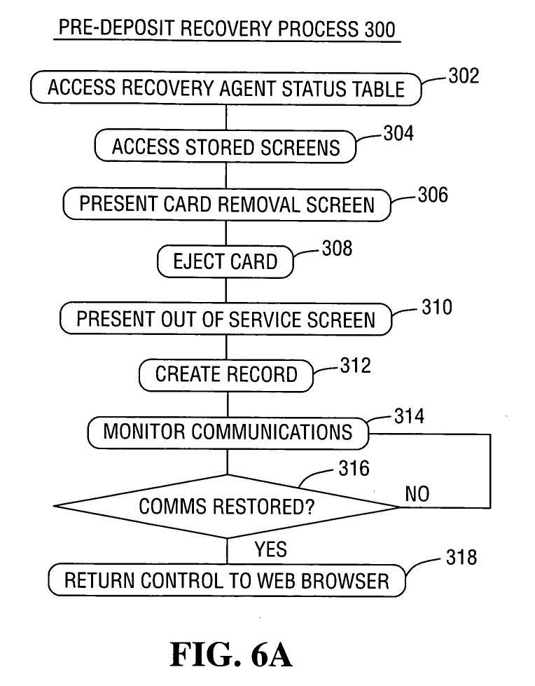

Normal operation of the ATM 10 will now be described with reference to FIGS. 4A to 4C, which together form a flowchart illustrating the operation of the ATM 10 under normal conditions (normal process 200); that is, where no fault occurs during a transaction. Reference will also be made to FIG. 5, which is a diagram illustrating a status table stored in the error recovery agent 90.

Normal Process 200

During normal operation, the Web browser 80 initially parses a welcome screen (step 202) received from the Web server 112. The welcome screen includes text inviting a customer to insert his/her card, which is rendered on the display 18c, and an ActiveX object that controls the card reader device 18a (the ActiveX card object).

The card reader device 18a receives an ATM card from a customer (step 204), and notifies the ActiveX card object executed by the Web browser 80 that a card has been received and provides information read from the ATM card, including an account number (step 206).

The card reader device 18a also notifies the error recovery agent 90 that a card has been received (and provides the account number read from the card) (step 208) because the agent 90 registered with the card reader device 18a for this type of event.

The error recovery agent 90 updates a status table 120 (entry 122, which is blank by default) (FIG. 5) to record the account number from the card (step 210).

The Web browser 80 then sends a next screen request to the Web server 112 including the account number.

The Web server 112 should respond to this request from the Web browser 80 by providing a PIN entry screen, which includes text (“Please enter your personal identification number”) and an ActiveX encrypting keypad object to control the encrypting keypad device 18e.

The Web browser 80 parses this response (step 212). This involves the Web browser 80 rendering any required information on the display 18c and controlling any devices 18 required by the PIN entry screen. In this example, the Web browser 80 renders the text “Please enter your personal identification number” on the display 18c and controls the encrypting keypad device 18e using the ActiveX encrypting keypad object.

The customer then enters his/her PIN, which the encrypting keypad device 18e encrypts and conveys to the ActiveX encrypting keypad object in the Web browser 80 (step 214).

The Web browser 80 then transmits the encrypted PIN to the Web server 112 (step 216). The Web server 112 should respond with a transaction selection screen listing the types of transaction that the customer may select and including an ActiveX FDK object.

The Web browser 80 then parses the transaction selection screen (step 218) rendering the transaction screen on the display 18c.

The customer then selects a transaction from a list presented on the display 18c using the FDKs 18d, in this example, the customer selects a cash deposit transaction. The ActiveX FDK object in the Web browser 80 detects this selection (step 220). The Web browser 80 then transmits the transaction request to the Web server 112 (step 222).

The Web server 112 should respond to this transaction request from the Web browser 80 by providing a deposit screen, which includes text (“Please enter the cash you would like to deposit”) and the ActiveX depository object.

The Web browser 80 then parses the deposit screen (step 224), which involves the Web browser 80 rendering text on the display 18c that invites the customer to deposit cash, and executing the ActiveX depository object that controls the cash depository 18g.

The customer then inserts the amount of money he/she will deposit, in this example $200, which is received by the cash depository 18g. The cash depository 18g counts the inserted cash (the $200) and notifies the Web browser 80 that $200 has been received (step 226).

The cash depository 18g also notifies the error recovery agent 90 that $200 has been received (step 228). The error recovery agent 90 updates its status table (entry 124, which is blank by default) to indicate the amount received by the cash depository 18g (step 230), namely, $200.

The Web browser 80 then transmits to the Web server 112 a request to credit the customer's account with the received money (that is, the $200) (step 232).

In response to this notification, the Web server 112 updates the financial institution's account information for that customer to indicate that the amount of cash has been deposited, and should send a confirmation screen to the Web browser 80 indicating that the customer's account has been updated.

The Web browser 80 then parses this confirmation screen (step 234), rendering text on the display 18c inviting the customer to remove his/her card, and executing the ActiveX card object to instruct the card reader device 18a to eject the customer's card.

The card reader device 18a detects when the customer removes the card, and notifies the ActiveX card object in the Web browser 80 accordingly (step 236).

The card reader device 18a also notifies the error recover agent 90 when the customer removes the card (step 238).

On receipt of this notification, the error recovery agent 90 purges all entries for that transaction in its status table (step 240) because the transaction has been completed successfully.

The operation of the ATM then reverts to step 202, which involves parsing the welcome screen.

Operation of the ATM in the Event of a Fault

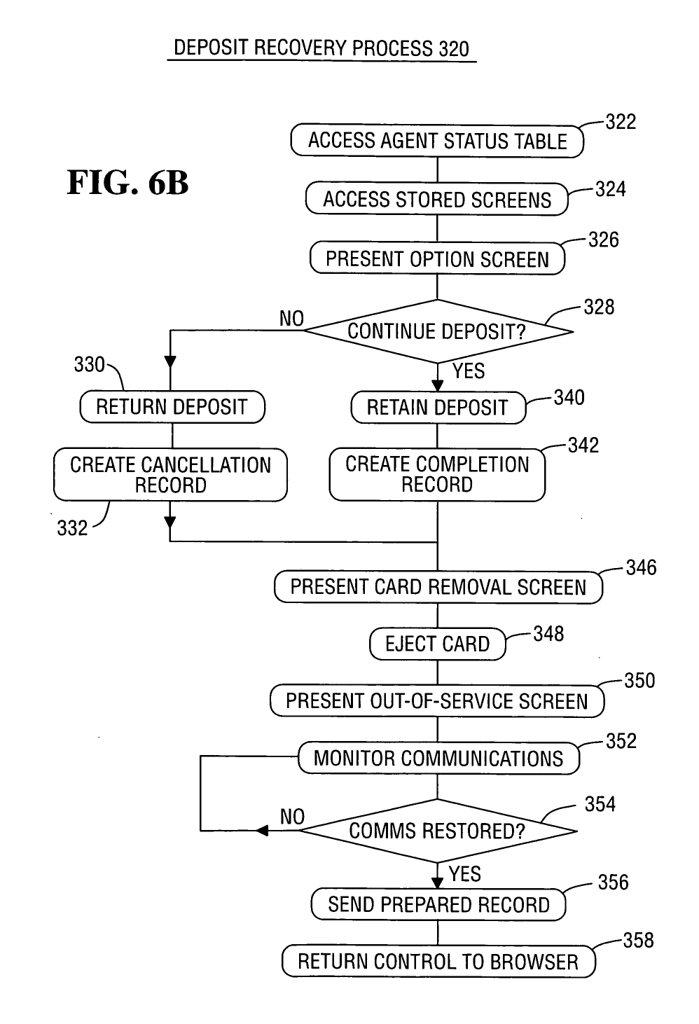

During normal operation, as described with reference to FIGS. 4A and 4B, the Web browser sends a heartbeat to the error recovery agent 90 every two seconds to indicate that the Web browser 80 is functioning correctly and that it is receiving timely responses from the Web server 112. In the event that the Web browser does not send a heartbeat to the error recovery agent 90, the error recovery agent 90 will implement an error recovery process. The error recovery process will now be described with reference to FIGS. 6A and 6B, which are flowcharts illustrating the operation of the ATM 10 when a fault develops during a transaction.

Error Recovery Process 300

When a fault is detected prior to step 226 then the error recovery agent 90 implements the pre-deposit recovery process 300 (FIG. 6A).

Initially, the error recovery agent 90 accesses the status table 120 to obtain the account number of the customer (step 302).

The error recovery agent 90 then accesses a screen repository 92 (FIG. 2) within the agent 90 (step 304) to locate a card removal screen, and then presents the card removal screen on the display 18c (step 306). The card removal screen informs the customer: (i) that the ATM has to go out of service, (ii) that the customer's account has not been changed, and (iii) that the customer should remove his/her card.

The error recovery agent 90 then instructs the card reader 18a to eject the customer's card (step 308).

Once the card has been removed by the customer, the error recovery agent 90 presents an out-of-service screen on the display 18c indicating that the ATM 10 cannot be used at present (step 310). If the customer does not remove his/her card within a predetermined period, then the card reader 18a may be instructed to capture the customer's card.

The error recovery agent 90 then writes an electronic record to the disk drive 36, and optionally instructs the journal printer 18h to print a record (step 312). The record (written electronically and printed by the journal printer 18h) includes the account number retrieved from the status table 120, the time at which the failure occurred, the date on which the failure occurred, the type of error (if known), and the action taken (card returned to the customer, card captured, card jammed in card reader 18a, or the like).

The error recovery agent 90 then attempts to contact the Web server 112 (which may be implemented by monitoring the network connection 18i to detect when communications are restored) (step 314).

Once communications are restored (step 316), the error recovery agent 90 uploads the electronic record to the Web server 112 (either directly or via the Web browser 80). The Web server 112 can reconcile the customer's account because it also records an incomplete transaction for that customer.

The error recovery agent 90 then returns control of the ATM 10 back to the Web browser 80 (step 318). The Web browser 80 defaults to step 202 of normal process 200, which involves presentation of the welcome screen.

Deposit Recovery Process 320

When a fault is detected after step 224 but before the transaction is successfully completed, then the error recovery agent 90 implements the deposit recovery process 320 (FIG. 6B).

Initially, the error recovery agent 90 accesses the status table 120 to obtain the account number of the customer (from entry 122) and the amount of money deposited (from entry 124) (step 322).

The error recovery agent 90 then accesses the screen repository 92 (FIG. 2) within the agent 90 (step 324).

The error recovery agent 90 then presents an option screen (step 326) that explains to the customer that there is a problem in executing the transaction, and that provides the customer with an option of receiving their cash from the depository or continuing with the deposit.

If the customer opts to receive their deposit, then the error recovery agent 90 detects this (step 328) and instructs the cash depository to return the deposit to the customer (step 330). The error recovery agent 90 writes a cancellation electronic record to the disk drive 36, and optionally instructs the journal printer 18h to print a record (step 332). The record (written electronically and printed by the journal printer 18h) includes the account number retrieved from the status table 120, the time at which the failure occurred, the date on which the failure occurred, the type of error (if known), and the action taken (inserted cash was returned to customer, and the like).

If the customer opts to continue with their deposit, then the error recovery agent 90 detects this (step 328) and instructs the cash depository to retain the deposit (step 340). The error recovery agent 90 then writes an electronic completion record to the disk drive 36, and optionally instructs the journal printer 18h to print a record (step 342). The record (written electronically and printed by the journal printer 18h) includes the account number retrieved from the status table 120, the time at which the failure occurred, the date on which the failure occurred, the type of error (if known), and the action taken (inserted cash ($200) was retained for crediting to the customer's account, and the like).

The error recovery process 320 then proceeds (irrespective of the choice made at step 328) to presenting a card removal screen on the display 18c (step 346). The card removal screen informs the customer: (i) that the ATM has to go out of service, (ii) that the transaction has been completed according to the customer's request, and (iii) that the customer should remove his/her card.

The error recovery agent 90 then instructs the card reader 18a to eject the customer's card (step 348).

Once the card has been removed by the customer, the error recovery agent 90 presents an out-of-service screen on the display 18c indicating that the ATM 10 cannot be used at present (step 350).

The error recovery agent 90 then attempts to contact the Web server 112 (which may be implemented by monitoring the network connection 18i to detect when communications are restored) (step 352).

Once communications are restored (step 354), the error recovery agent 90 uploads the electronic record (either the cancellation record or the completion record, depending on the choice made by the customer at step 328) to the Web server 112 (step 356). This is performed either directly or via the Web browser 80. The Web server 112 can reconcile the customer's account because it also records an incomplete transaction for that customer.

The error recovery agent then returns control of the ATM 10 back to the Web browser 80 (step 358). The Web browser 80 defaults to step 202 of the normal process 200, which is presentation of the welcome screen.

In other examples, a dispense transaction may be selected by a user, and an error may occur at some point. In such an example, if the error occurred prior to the Web server 112 authorizing the dispense transaction, then the error recovery agent 90 would implement a similar process to the pre-deposit recovery process 300, although reference would be made to a dispense transaction rather than a deposit transaction. If the error occurred after cash has been counted by the cash dispenser device 18f, but before the-cash has been dispensed to the customer, then the error recovery agent 90 implements its programmed actions. This may involve dispensing the counted cash to the customer and writing an electronic record to the disk drive 36, where the electronic record includes the account number retrieved from the status table 120, the time at which the failure occurred, the date on which the failure occurred, the type of error (if known), and the steps taken. The steps taken may be recorded in the electronic record as: “start, card inserted, cash counted, failure, cash presented, cash removed, card returned, card taken, end”.

The customer may be informed about the action taken regarding his/her account, for example, that the dispensed cash would be debited from his/her account.

This electronic record is typically transmitted to the Web server 112 once the fault is corrected (for example, when communications are restored). When the Web server 112 receives this message, it identifies the transaction referred to by the electronic record, and then parses the record to ascertain what steps were taken by the error recovery agent 90. The Web server 112 can then update the customer's account either by debiting the amount of money dispensed, or cancelling the transaction if the error recovery agent 90 did not dispense the cash to the customer.

It will now be appreciated that the above embodiment has the advantage that if there is a failure in communications between the Web browser 80 and the Web server 112 during a transaction, then the error recovery agent 90 is able to complete the transaction and inform the user accordingly.

The error recovery agent 90 does not need to know about the business logic (for example, the state of the transaction being executed by the Web browser 80) because the Web server 112 can match the electronic record to an incomplete transaction session. This allows all of the business logic for confirming or reversing a transaction to remain at the Web server 112 side.

The above embodiment has the advantage that an error recovery agent is provided that may be vendor independent (it may execute on any ATM compliant with the CEN XFS standard), so that the error recovery agent may be used in a multi-vendor environment.

The above embodiment also allows a financial institution, or any other owner or operator of an ATM, to provide a Web-based transaction flow without having to provide for error recovery.

Various modifications may be made to the above described embodiment within the scope of the invention, for example, in the above embodiment, the Web browser 80 sends a request to the Web server 112 for every screen that is required; in other embodiments, the Web browser 80 may receive an applet from the Web server 112 that allows the Web browser 80 to display a series of screens prior to sending another request to the Web server 112.

In other embodiments, the error recovery agent may be provided as a wrapper around the Web browser so that the error recovery agent automatically detects all messages sent to and from the Web browser, without the need for a heartbeat.

In other embodiments, the error recovery agent may be provided as a proxy server that passes requests from the Web browser to the Web server, so that the error recovery agent automatically detects all messages sent to and from the Web browser.

In other embodiments, the error recovery agent 90 may have independent communication with the Web server 112, such as using a cellular network, so that the error recovery agent 90 can communicate directly with the Web server 112.

In other embodiments, the error recovery agent 90 may be programmed to initiate error recovery for devices 18 within the ATM 10, for example, by instructing the ATM controller 18k to reboot, or to terminate the Web browser 80 and then restart the Web browser 80.

In other embodiments, the error recovery agent 90 may be operable to receive a recovery request from the run-time platform 70 or a management application executing on the ATM 10, and to implement a recovery process in response to the recovery request.

In other embodiments, the error recovery agent 90 may record more information than described in the above embodiment, for example, the agent 90 may record the status of each device, each event that occurs, and the like. In some embodiments, the error recovery agent 90 may only record if the Web browser 80 is still functioning correctly, and the status of any devices that have received or are receiving media from a customer, or have dispensed or are dispensing media to a customer.

In other embodiments the error recovery agent may record less information than described in the above-embodiment, for example the agent 90 may not record the card number and other consumer details because the Web server knows that a session with that particular customer, from that particular ATM at that particular date and time has not terminated properly. This means that the Web server should be able to reconcile the failed transaction even without the card number or other customer details (by using the identity of the ATM and timestamp information).

In other embodiments, the Web browser 80 may send the error recovery agent 90 a notification each time a new page has been loaded by the Web browse 80. This allows the error recovery agent 90 to decide when it should implement an error recovery process to take control of the ATM 10.

In other embodiments, if an error occurs in a cash dispense transaction after the requested cash has been counted by the cash dispenser device 18f, but before the cash has been dispensed to the customer, then the error recovery agent 90 In other embodiments, an SST other than an ATM may be provided.

In other embodiments, the Web browser 80 may pass context details to the error recovery agent 90 to help with conflict resolution; for example, the error recovery agent 90 may store or be able to access full transaction information.

1. A self-service terminal comprising:
a Web client for connecting to a Web server remote from the terminal, the Web client being operable to render information to a customer of the terminal and to parse commands received from the Web server;
a display for presenting the rendered information to the customer;
at least one customer interface device for interfacing with the customer under control of the Web client; and
an error recovery agent executing on the terminal and operable to monitor the Web client to detect any failure, and in the event of a failure (i) to take control of the display and the at least one customer interface device from the Web client, (ii) to return inserted media to the customer (iii) to inform the customer about a resolution of any pending transaction when the failure occurred, and (iv) to inform the Web server of actions taken regarding the pending transaction.

2. A self-service terminal according to claim 1, wherein the Web client is a Web browser component.

3. A self-service terminal according to claim 1, wherein the terminal includes a plurality of customer interface devices.

4. A self-service terminal according to claim 1, wherein the terminal further comprises a plurality of internal devices.

5. A self-service terminal according to claim 1, wherein the terminal includes a cash dispenser and is operable to perform financial transactions.

6. A method of recovering a self-service terminal having a transaction flow controlled by a remote Web server, the method comprising:
detecting a failure with the remote Web server;
accessing a local transaction flow, in response to a detected failure;
returning inserted media to the customer using the local transaction flow;
informing the customer about a resolution of any pending transaction using the local transaction flow; and
informing the Web server of actions taken regarding the pending transaction using the local transaction flow.

7. A method according to claim 7, wherein the step of informing the Web server of actions taken regarding the pending transaction is performed subsequent to resolution of the failure with the remote Web server.

8. A computer program for executing on a self-service terminal, the computer program comprising program instructions for implementing all of the steps of claim 7.

9. A computer program according to claim 9, wherein the program is embodied on a record medium.

10. A method of recovering a self-service terminal having a transaction flow controlled by a remote Web server, the method comprising:
detecting a failure with the remote Web server;
accessing a local transaction flow, in response to the detected failure;
informing the customer about a resolution of any pending transaction using the local transaction flow; and
informing the Web server of actions taken regarding the pending transaction using the local transaction flow.
